(19) United States
(12) Patent Application Publication
(10) Pub. No.: US 2024/0354168 A1
(43) Pub. Date: Oct. 24, 2024

(54) EXTENSIBILITY FOR CUSTOM DAY-2 OPERATIONS ON CLOUD RESOURCES

(71) Applicant: VMware LLC, Palo Alto, CA (US)

(72) Inventors: Miroslav Shipkovenski, Sofia (BG); Petya Aleksandrova, Sofia (BG); Elina Valinkova, Sofia (BG); Martin Petkov, Sofia (BG); Vera Mollova, Sofia (BG); Lora Borisova, Sofia (BG)

(73) Assignee: VMware LLC, Palo Alto, CA (US)

(21) Appl. No.: 18/137,158

(22) Filed: Apr. 20, 2023

(51) Int. Cl. G06F 9/50; G06F 9/455

(52) U.S. Cl. CPC G06F 9/5077; G06F 9/45558; G06F 2009/4557; G06F 2009/45595

(57) ABSTRACT

The present disclosure is related to devices, systems, and methods for extensibility for custom day-2 operations on cloud resources. One example includes receiving an indication of a resource type of a software-defined datacenter via an interface of a cloud automation platform, receiving an indication of an ABX action via the interface, associating the resource type with the ABX action to create a resource action responsive to an input via the interface, and deploying a blueprint containing a resource of the resource type, wherein the resource action is executable to modify an internal state of the resource.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for extensibility for custom day-2 operations on cloud resources according to one or more embodiments of the present disclosure.

FIG. 2 illustrates a system for extensibility for custom day-2 operations on cloud resources according to one or more embodiments of the present disclosure.

FIG. 3 illustrates an example user interface associated with extensibility for custom day-2 operations on cloud resources according to one or more embodiments of the present disclosure.

FIG. 4 is a diagram of a system for extensibility for custom day-2 operations on cloud resources according to one or more embodiments of the present disclosure.

FIG. 5 is a diagram of a machine for extensibility for custom day-2 operations on cloud resources according to one or more embodiments of the present disclosure.

### DETAILED DESCRIPTION

As referred to herein, a virtual computing instance (VCI) covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

Cloud automation platforms (e.g., VMware's vRealize Automation (vRA)) offer end users a wide variety of cloud resources for provisioning. These resources may be exposed through a catalog of templates, which consumers use to deploy cloud applications and/or services. Users manage provisioned cloud resources (VCIs, network, storage, etc.) by performing second day (referred to herein as “day-2”) operations and/or actions, which are predefined on an automation platform. Complex use cases, however, involve a non-standard set of resource actions that are be defined and implemented by the automation users themselves. There is a need for extensibility mechanisms to fill that gap by providing infrastructure administrators with the right tools to build and maintain their customized software as a service (SaaS) solutions.

One example for cloud-native extensibility mechanism is “serverless.” Serverless is a development model that allows developers to build and run small, lightweight scripts of code without having to manage servers. Under a serverless model, a cloud provider runs physical servers and dynamically allocates their resources on behalf of users who can deploy code straight into a public or private cloud. This makes for a good extensibility mechanism for cloud users who wish to concentrate on their apps instead of managing complex infrastructure. Embodiments of the present disclosure address the problem of providing an extensibility mechanism for custom day-2 operations on cloud resources by utilizing the serverless development model. For instance, embodiments herein include adding the possibility of running Action Based Extensibility (ABX) actions (e.g., Amazon Web Service (AWS) lambdas, Azure Functions, etc.) as day-2 operations of cloud resources whose lifecycle is managed by a cloud automation platform such as, vRealize Automation (vRA) 8.x/Cloud, for instance.

As referred to herein, a blueprint is a specification for cloud resources deployed by a user. Blueprint architects assemble software components such as VCIs, storage, networks, etc. into blueprints that define the terms users request from a catalog. Typically, blueprints describe fully-fledged applications that include multiple components. A catalog, as referred to herein, includes catalog items (e.g., published blueprints). A catalog provides consumers with a uniform request experience when they might be requesting cloud applications developed on-premises, in the cloud instance, or from other content sources. Deployed blueprints may also be referred to as cloud resources. A resource action, as referred to herein, is an association between an ABX action and a resource type of a blueprint. Stated differently, a resource action makes changes to deployed cloud resources. The present disclosure allows users to configure custom day-2 actions that make changes to deployed cloud resources. While cloud automation platforms may provide a predefined list of operations and/or actions that apply to cloud resources (depending on their type), custom resource actions are operations defined by cloud users for a particular type of resource.

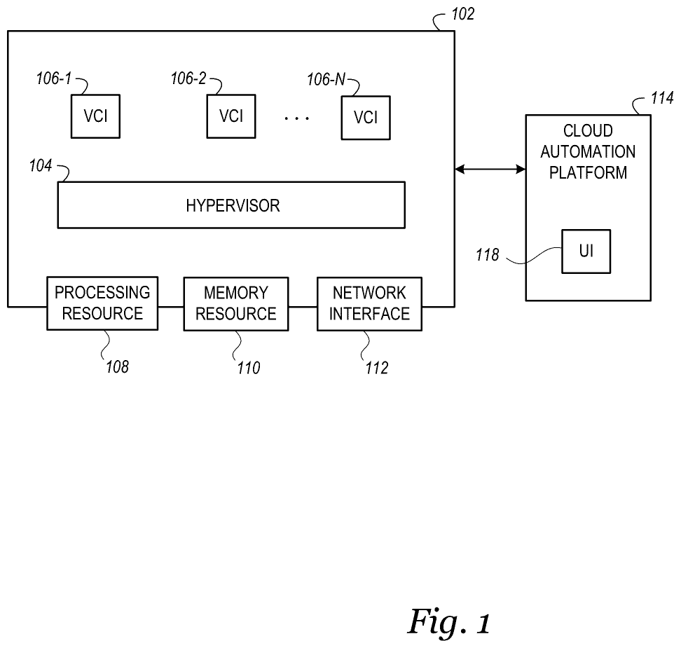

FIG. 1 is a diagram of a host and a system for extensibility for custom day-2 operations on cloud resources according to one or more embodiments of the present disclosure. The host 102 can be provisioned with processing resource(s) 108 (e.g., one or more processors), memory resource(s) 110 (e.g., one or more main memory devices and/or storage memory devices), and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of VCIs 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs 106 can be local and/or remote to the host 102 (e.g., the VCIs 106 can be ultimately executed by hardware that may not be physically tied to the VCIs 106). For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. In some embodiments, the host 102 can be connected to (e.g., in communication with) a cloud automation platform 114, which can be deployed on a VCI 106.

The cloud automation platform 114 can provide a secure portal where authorized administrators, developers, or business users can request new IT services and/or manage cloud and IT resources while ensuring compliance with business policies. The cloud automation platform 114 can be used to build and/or manage a multi-vendor cloud infrastructure, for instance. One example of such a cloud automation platform is VMware's vRealize Automation (vRA), though embodiments herein are not so limited.

A UI 118 of the cloud automation platform 114 can be used to build and/or manage a cloud infrastructure. One example of such a development platform is VMware's vRealize Automation (vRA), though embodiments herein are not so limited. vRA is a cloud management layer that sits on top of one or more clouds (e.g., different clouds). It can provision complex deployments and offer governance and management of these workloads and the resources in the cloud. The cloud automation platform 114 can be designed to automate multiple clouds with secure, self-service provisioning.

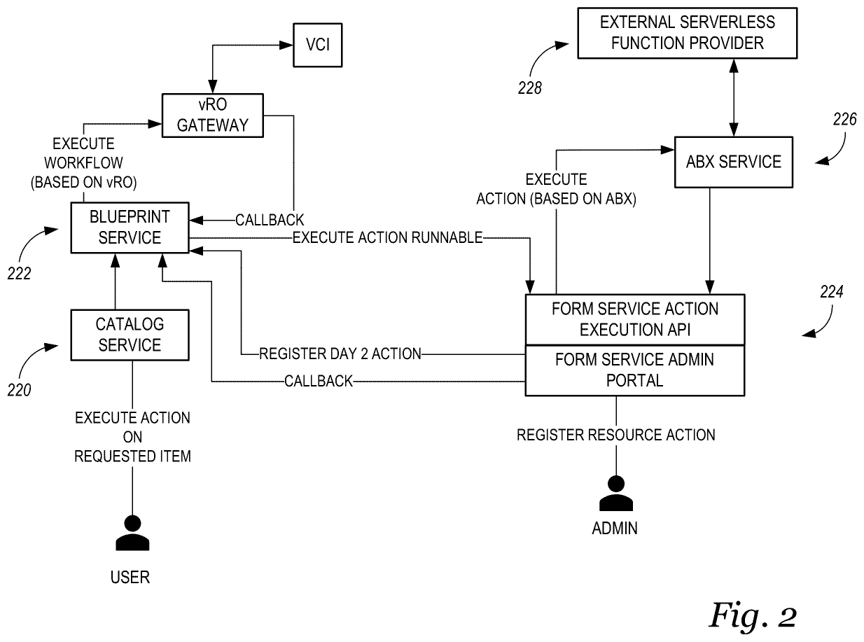

FIG. 2 illustrates a system for extensibility for custom day-2 operations on cloud resources according to one or more embodiments of the present disclosure. The ABX service 226 provides a lightweight and flexible run-time engine interface to leverage Function-as-a-Service (FaaS) functionality in vRA Cloud Assembly. In simple terms, this feature can be used to run simple code-snippets written in one of the supported popular programming languages (Python, NodeJS and PowerShell), without requiring any additional effort on the user's site. Once written, these actions can be run repeatedly on any of the currently supported public cloud providers 228, AWS and Azure, or even on-prem by integrating a new VMware Cloud Extensibility Appliance.

Integration wise, the starting point for the whole flow is the so-called Catalog service 220 which in short accepts provider registrations. Any microservice can provide users with new resource types or day-2 actions if it is registered within the Catalog. In the current scenario, there is a Form service 224 which is a provider that acts as a proxy between the user portal and the ABX service 226 in order to execute serverless functions. The form service 224 can include a form service action execution API and a form service admin portal, for instance.

Whenever a user requests a Custom Resource Type based on ABX actions, the request gets sent to the Catalog service 220 which in turn sends it to the Blueprint service 222. From there, the Blueprint service 222 decides on the appropriate provider which should handle this request. In the cases for ABX-based Custom Resource Types, the selected provider is the Form service 224. After the request arrives, the Form service 224 checks the resource type specified in the request and selects the actions corresponding to the requested operation. When the operation is supposed to be performed on a Custom Resource Type based on ABX actions, then the definition of the Custom Resource Type is retrieved by the Form service database, where this information is present. Then, from the Custom Resource Type information the Create, Read, Update and Delete operations are extracted. According to the data in the request, the appropriate ABX operation is started. If the request is intended for a Custom Resource Type, then it needs to be a day-2 operation for a built-in type. In that case, the Form service 224 retrieves information about the day-2 operation, where it stores which procedure needs to be initiated and sends entire relevant information in a request to the ABX service 226.

Finally, Form service 224 sends a request to the ABX service 226 containing the relevant input information provided by the user in the UI portal. Thereafter, ABX service 226 receives this request and starts a serverless function on an appropriate cloud endpoint 228.

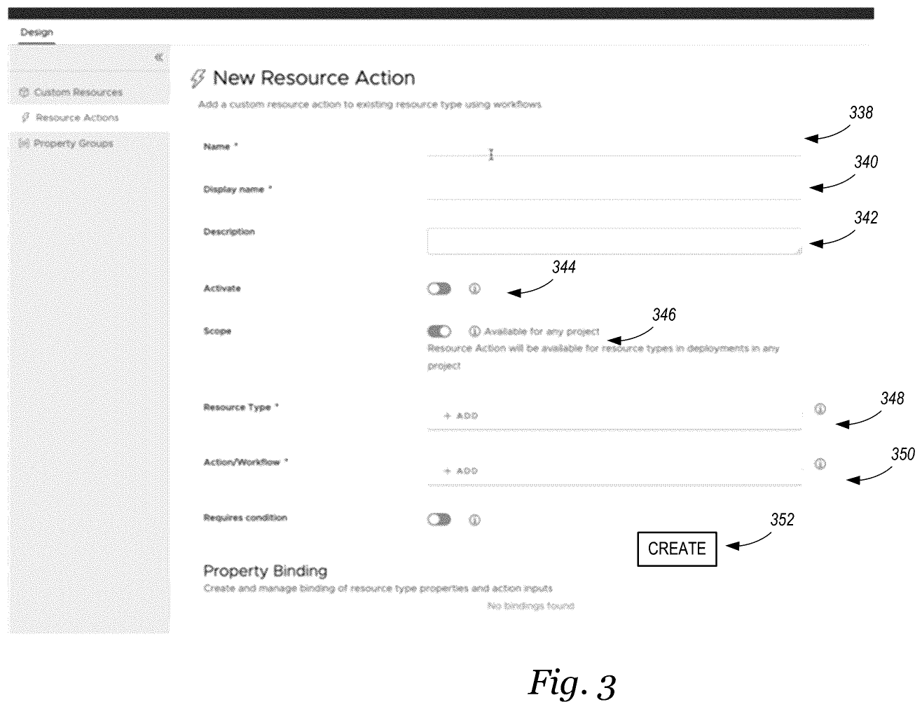

FIG. 3 illustrates an example user interface associated with extensibility for custom day-2 operations on cloud resources according to one or more embodiments of the present disclosure. The UI illustrated in FIG. 3 can be a UI associated with creating a new resource action based on ABX, for instance. In an example, in order for the UI illustrated in FIG. 3 to be displayed, a user can navigate to Cloud Assembly>Design>Resource Actions>New Resource Action.

As shown in the example illustrated in FIG. 3, the UI can include a name field 338, a display name field 340, a description field 342, an activate toggle 344, a scope toggle 346, a resource type field 348, an action/workflow field 350, and a create button 352. It is to be understood that the types, appearance, and/or layout of the display elements of the UI illustrated in FIG. 3 are not intended to be taken in a limiting sense. Embodiments of the present disclosure are not limited to the particular example illustrated in FIG. 3.

The name field 338 can be used to input a name of the resource action to be created. The display name 340 can be used to input a name to be displayed (e.g., during deployment) for the resource action to be created. In some embodiments the display name and the name of the resource action will be the same. In other embodiments, the display name and the name will be different. The description field 342 can be used to input a description of the resource action. The activate toggle 344 can be selected if immediate availability of the resource is desired. The scope toggle 346 can be selected in order to define which project(s) can consume this resource. If, for example, all projects are desired (default) then the toggle may be selected.

The resource type field 348 can be used to input the resource type that the action is to be associated with (e.g., bound to). In an example, the resource type is Cloud.vSphere.Machine. The action/workflow field 350 can be used to input the action (e.g., ABX action). In some embodiments, an action can be selected from a dropdown list of preexisting actions. The create button 352 can be selected to associate the input resource type with the selected ABX action to create the resource action.

Once the resource action is created via the UI illustrated in FIG. 3, a blueprint containing a standard resource type (e.g., K8s Namespace) can be created. The created blueprint can be deployed. After successful deployment, the resource can be inspected. The newly-created resource action is then visible (e.g., in a dropdown list in the upper right corner of the details view of the resource). The resource action can be executed in the deployed blueprint. As known to those of skill in the art, execution can modify an internal state of the resource.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

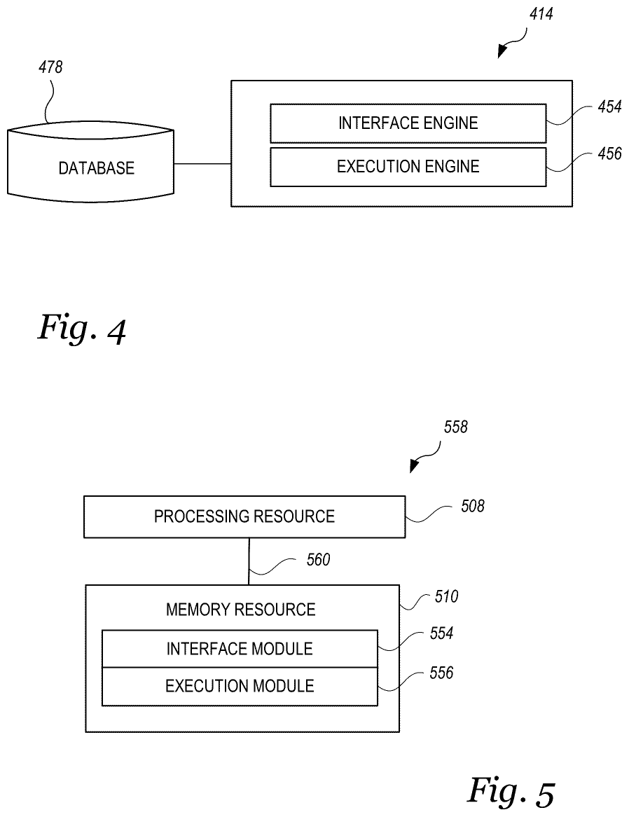

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 408 in FIG. 4. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 4 is a diagram of a system 414 for extensibility for custom day-2 operations on cloud resources according to one or more embodiments of the present disclosure. The system 414 can include a database 478 and/or a number of engines, for example interface engine 454, execution engine 456, and can be in communication with the database 478 via a communication link. The system 414 can include additional or fewer engines than illustrated to perform the various functions described herein. The system can represent program instructions and/or hardware of a machine (e.g., machine 558 as referenced in FIG. 5, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the interface engine 454 can include a combination of hardware and program instructions that is configured to provide an interface of a cloud automation platform. The interface can include a first portion configured to receive an indication of a resource type of a software-defined datacenter (SDDC). The interface can include a second portion configured to receive an indication of an Action Based Extensibility (ABX) action. The interface can include a third portion configured to receive an input to associate the resource type with the ABX action to create a resource action. In some embodiments, the execution engine 456 can include a combination of hardware and program instructions that is configured to execute the resource action in a deployed blueprint containing a resource of the resource type to modify an internal state of the resource.

FIG. 5 is a diagram of a machine 558 for extensibility for custom day-2 operations on cloud resources according to one or more embodiments of the present disclosure. The machine 558 can utilize software, hardware, firmware, and/or logic to perform a number of functions. The machine 558 can be a combination of hardware and program instructions configured to perform a number of functions (e.g., actions). The hardware, for example, can include a number of processing resources 508 and a number of memory resources 510, such as a machine-readable medium (MRM) or other memory resources 510. The memory resources 510 can be internal and/or external to the machine 548 (e.g., the machine 548 can include internal memory resources and have access to external memory resources). In some embodiments, the machine 548 can be a VCI. The program instructions (e.g., machine-readable instructions (MRI)) can include instructions stored on the MRM to implement a particular function (e.g., an action such as collecting data, as described herein). The set of MRI can be executable by one or more of the processing resources 508. The memory resources 510 can be coupled to the machine 548 in a wired and/or wireless manner. For example, the memory resources 510 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 510 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 508 can be coupled to the memory resources 510 via a communication path 560. The communication path 560 can be local or remote to the machine 558. Examples of a local communication path 560 can include an electronic bus internal to a machine, where the memory resources 510 are in communication with the processing resources 508 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 560 can be such that the memory resources 510 are remote from the processing resources 508, such as in a network connection between the memory resources 510 and the processing resources 508. That is, the communication path 560 can be a network connection. Examples of such a network connection can include a local area network (LAN), wide area network (WAN), personal area network (PAN), and the Internet, among others.

As shown in FIG. 5, the MRI stored in the memory resources 510 can be segmented into a number of modules 554, 556 that when executed by the processing resources 508 can perform a number of functions. As used herein a module includes a set of instructions included to perform a particular task or action. The number of modules 554, 556 can be sub-modules of other modules. For example, the execution module 556 can be a sub-module of the interface module 554 and/or can be contained within a single module. Furthermore, the number of modules 554, 556 can comprise individual modules separate and distinct from one another. Examples are not limited to the specific modules 554, 556 illustrated in FIG. 5.

Each of the number of modules 554, 556 can include program instructions and/or a combination of hardware and program instructions that, when executed by a processing resource 508, can function as a corresponding engine as described with respect to FIG. 4. For example, the interface module 554 can include program instructions and/or a combination of hardware and program instructions that, when executed by a processing resource 508, can function as the interface engine 454, though embodiments of the present disclosure are not so limited.

The machine 558 can include an interface module 554, which can include instructions to provide an interface of a cloud automation platform. In some embodiments, the interface includes a first portion configured to receive an indication of a resource type of a software-defined datacenter (SDDC), a second portion configured to receive an indication of an Action Based Extensibility (ABX) action, and a third portion configured to receive an input to associate the resource type with the ABX action to create a resource action. The machine 558 can include an execution module 556, which can include instructions to execute the resource action in a deployed blueprint containing a resource of the resource type to modify an internal state of the resource.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving an indication of a resource type of a software-defined datacenter (SDDC) via an interface of a cloud automation platform;
receiving an indication of an Action Based Extensibility (ABX) action via the interface;
associating the resource type with the ABX action to create a resource action responsive to an input via the interface; and
deploying a blueprint containing a resource of the resource type, wherein the resource action is executable to modify an internal state of the resource.

2. The method of claim 1, wherein the resource action is a custom resource action defined by a user for the resource type.

3. The method of claim 1, wherein the resource action is a predefined resource action.

4. The method of claim 1, wherein the ABX action is a serverless script of code.

5. The method of claim 1, wherein the ABX action is an Amazon Web Services lambda.

6. The method of claim 1, wherein the ABX action is a Microsoft Azure Function.

7. A non-transitory machine-readable medium having instructions stored thereon which, when executed by a processor, cause the processor to:
provide an interface of a cloud automation platform, the interface comprising:
a first portion configured to receive an indication of a resource type of a software-defined datacenter (SDDC);
a second portion configured to receive an indication of an Action Based Extensibility (ABX) action; and
a third portion configured to receive an input to associate the resource type with the ABX action to create a resource action; and
execute the resource action in a deployed blueprint containing a resource of the resource type to modify an internal state of the resource.

8. The medium of claim 7, including instructions to provide a fourth portion configured to receive a name of the resource action.

9. The medium of claim 7, including instructions to provide a fifth portion configured to receive a description of the resource action.

10. The medium of claim 7, wherein the first portion is configured to receive the indication of the resource type via a selection of the resource type from a list of resource types.

11. The medium of claim 7, wherein the list of resource types includes:
a disk;
a virtual computing instance; and
a volume.

12. The medium of claim 7, wherein the second portion is configured to receive the indication of the ABX action via a selection of the ABX action from a list of ABX actions.

13. The medium of claim 12, wherein the list of ABX actions includes:
create;
update;
delete; and
get.

14. The medium of claim 12, wherein the list of ABX actions is determined based on the resource type.

15. The medium of claim 14, wherein the resource type is a virtual computing instance, and wherein the list of ABX actions includes:
power on;
power off; and
shut down guest operating system.

16. A system, comprising:
an interface engine configured to provide an interface of a cloud automation platform, the interface comprising:
a first portion configured to receive an indication of a resource type of a software-defined datacenter (SDDC);
a second portion configured to receive an indication of an Action Based Extensibility (ABX) action; and
a third portion configured to receive an input to associate the resource type with the ABX action to create a resource action; and
an execution engine configured to execute the resource action in a deployed blueprint containing a resource of the resource type to modify an internal state of the resource.

17. The system of claim 16, wherein the ABX action is written in one of:
Python;
Node JavaScript; and
PowerShell.

18. The system of claim 16, wherein the ABX action is a serverless script of code.

19. The system of claim 16, wherein the list of resource types includes:
a disk;
a virtual computing instance; and
a volume.

20. The system of claim 20, wherein the resource type is a virtual computing instance, and wherein the list of ABX actions includes:
power on;
power off; and
shut down guest operating system.
